(19) United States
(12) Patent Application Publication
(10) Pub. No.: US 2026/0154720 A1
(43) Pub. Date: Jun. 4, 2026

(54) ARTIFICIAL INTELLIGENCE ENABLED INTERACTIVE QUOTATION AND VIRTUAL HOME IMPROVEMENT PRODUCT AND SERVICE BUYING SYSTEM

(71) Applicant: Brandon Losik, Sorrento, FL (US)

(72) Inventor: Brandon Losik, Sorrento, FL (US)

(21) Appl. No.: 19/381,732

(22) Filed: Nov. 6, 2025

Related U.S. Application Data
(60) Provisional application No. 63/727,881, filed on Dec. 4, 2024.

(51) Int. Cl. G06Q 30/0601

(52) U.S. Cl. CPC G06Q 30/0611; G06Q 30/0643

(57) ABSTRACT

An artificial intelligence enabled system for a virtual roofing quotation and visualization platform is disclosed. The system includes a user computing device in communication with a user network and an application server configured to generate, adjust, and display a roofing project quotation. A data integration module retrieves project data from one or more third-party databases. An estimation module automatically generates line item estimates, and a quotation module compiles those into a roofing project quotation. A communication module transmits automated communications to a homeowner, while an artificial intelligence engine dynamically adjusts the line item estimates and roofing project quotation in response to user input. A display module presents a virtual representation of the roofing project alongside the roofing project quotation, enabling end-to-end remote interaction, pricing, and purchase of roofing services without requiring in-person site visits.

### CROSS-REFERENCE TO RELATED APPLICATIONS

The present application claims priority to U.S. Provisional Patent Application 63/727,881 filed on Dec. 4, 2024, entitled “ARTIFICIAL INTELLIGENCE ENABLED INTERACTIVE QUOTATION AND VIRTUAL HOME IMPROVEMENT PRODUCT AND SERVICE BUYING SYSTEM” the entire disclosure of which is incorporated by reference herein.

### TECHNICAL FIELD

The embodiments disclosed herein generally relate to computerized system for generating estimates and quotations for building projects, and more specifically relates to virtual platforms enabling the AI-driven generation of roofing quotations and estimates.

### BACKGROUND

Home improvement projects, particularly those involving structural renovations such as roofing, have traditionally relied on time-consuming, manual processes for estimation, pricing, and contracting. For decades, the standard approach required a contractor to physically visit a site, measure the area in question, assess material needs, and deliver a hand-prepared quote to the homeowner. While functional, this method was heavily dependent on the availability and accuracy of the contractor and lacked transparency or repeatability from the homeowner's perspective. Scheduling, miscommunication, and inconsistent measurement techniques often led to delays, budget overruns, and consumer dissatisfaction.

In response to increased demand for efficiency and digital convenience, various software tools emerged to help automate parts of the estimation process. However, many of these systems were either rudimentary calculators that required manual input from the contractor or basic quote generators that offered wide pricing ranges rather than project-specific, accurate estimates. These tools lacked integration with live datasets, aerial measurement systems, or intelligent interfaces to support non-technical homeowners through the decision-making process. Moreover, while some platforms improved aspects of contractor workflows, few were developed with the consumer's experience in mind.

Recent advancements in geospatial technologies, such as satellite imaging and aerial mapping, introduced the possibility of obtaining remote property measurements without needing to be physically present on-site. This opened the door for more sophisticated systems to integrate geographic data into estimation workflows. Nevertheless, such systems often required skilled users to interpret the data and still did not eliminate the need for follow-up inspections, quoting delays, or in-person negotiations. The opportunity to transform the entire roof-buying experience into a virtual, consumer-driven workflow remained largely unfulfilled.

At the same time, artificial intelligence (AI) and cloud computing have revolutionized digital services across multiple industries, yet their application to home improvement purchasing remains nascent. The power of AI to provide real-time guidance, personalize content, and adapt system behavior based on user interaction presents a unique opportunity to elevate quoting systems from static tools into dynamic, customer-centric platforms. However, existing systems often fail to leverage AI holistically, focusing instead on isolated improvements rather than creating a cohesive, intelligent ecosystem that walks a user from interest to transaction.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to an artificial intelligence enabled system for a virtual roofing quotation and visualization platform. The system allows a homeowner to generate, visualize, and interact with a precise roofing project quotation entirely through a digital interface. The platform replaces traditional in-person inspection methods with a digital process that leverages satellite data, proprietary estimation algorithms, and artificial intelligence. The system simplifies the process of roofing estimation, quotation, and purchase by integrating various hardware and software components through cloud-based architecture. It enables real-time quotation generation and modification, and provides a virtual visualization of the roofing project.

In some embodiments, the system includes a user computing device in operable communication with a user network. The user computing device may be any desktop, laptop, tablet, or mobile phone capable of interfacing with the system's graphical user interface. Through this interface, the user may input project-specific data including address, roof preferences, or budget constraints. The user computing device serves as the primary access point through which the homeowner initiates and interacts with the quotation workflow. All communications and adjustments to the roofing project quotation occur through this computing device.

The system further includes an application server in operable communication with the user network. The application server functions as the central processing unit for the platform, receiving data from the user computing device and distributing commands to various backend modules. It facilitates the operation of estimation logic, database access, AI-driven modifications, and user display rendering. In certain embodiments, the application server may be hosted in a cloud environment and offered as a software-as-a-service (SaaS) solution to other roofing providers. This architecture supports scalability and multi-user deployment while preserving data integrity.

A key component of the system is the data integration module, which is configured to receive project data from one or more third-party databases. These databases may include satellite imagery databases, regional roofing material cost databases, supplier availability databases, and contractor directories. The data integration module aggregates and normalizes this incoming data so it can be consumed by other components such as the estimation module or artificial intelligence engine. This enables the system to provide localized pricing, accurate material quantities, and region-specific options without requiring user expertise. By automating third-party data integration, the platform minimizes manual entry and enhances quotation accuracy.

The estimation module is configured to automatically generate a plurality of line item estimates based on the project data received from the data integration module. These line item estimates include measurements for roofing area, labor costs, delivery charges, tear-off disposal, underlayment, fasteners, and any additional items such as solar panels or insulation. The estimation module applies proprietary pricing algorithms that factor in regional cost adjustments, contractor margins, and seasonal pricing fluctuations. These calculations are performed in real time and update dynamically as new user inputs are received. The resulting estimates are highly granular and suitable for direct use in final contracting.

A quotation module is configured to automatically generate a roofing project quotation comprising the plurality of line item estimates. The quotation module compiles and formats the estimates into a user-readable format, allowing the homeowner to review both summary pricing and detailed breakdowns. The roofing project quotation is structured in a modular way, allowing the homeowner to approve or modify specific line items such as shingle type, color, or warranty options. Once compiled, the roofing project quotation may be stored in the system and presented on the user computing device through the display module. The quotation module supports exporting documents for signature or generating contracts based on the finalized quote.

The system further comprises a communication module configured to automatically transmit communications to a homeowner. These communications may include automated follow-ups to incomplete quotes, scheduling reminders, confirmations of quotation generation, or updates when pricing conditions change. The communication module may operate through SMS, email, voice calls, or in-app notifications depending on user preferences. It may be configured to use templated communication scripts or AI-generated responses to maximize user engagement and conversion. The automation of this communication cycle reduces the need for sales staff and improves lead follow-up efficiency.

An artificial intelligence engine is integrated into the system and is configured to dynamically adjust the plurality of line item estimates and the roofing project quotation based on user input. For example, when a user changes a preference for roofing material or indicates a budget constraint, the artificial intelligence engine can automatically re-calculate costs and suggest alternative configurations. The artificial intelligence engine can also analyze historical usage patterns and regional trends to recommend cost-saving options, upgrades, or incentives. This component transforms the system from a static calculator into a responsive sales assistant. It enables adaptive, personalized interactions without human intervention.

The display module is configured to generate a virtual display comprising the roofing project quotation and a virtual representation of a roofing project. The virtual representation may include satellite imagery overlays, 3D roof models, color simulations, and side-by-side comparisons of different product configurations. The display module may allow the user to toggle between views, zoom in on specific areas, and simulate roof appearance under different lighting or weather conditions. The roofing project quotation is presented alongside the visual data, helping the user understand the impact of each selection on overall cost. This visual interactivity builds trust and accelerates decision-making.

In some embodiments, the data integration module is further configured to retrieve project data from satellite geospatial databases. These databases provide aerial or top-down imagery of the user's property, enabling precise calculation of roof dimensions and pitch without requiring a physical site visit. The retrieved data is then used by the estimation module to calculate accurate material quantities and costs. Satellite data retrieval is automated and can be triggered based on address input from the user. This function significantly reduces project initiation time and allows for same-day quotation generation.

The estimation module may be configured to generate the plurality of line item estimates using proprietary pricing algorithms based on the project data. These algorithms are designed to capture real-time market fluctuations, regional labor rates, supplier shipping costs, and material demand surges. The estimation module may update the estimates continuously as data refreshes from the third-party databases. This enables the roofing project quotation to remain current and eliminates the inaccuracies associated with fixed or static pricing models. The integration of these pricing algorithms results in “to-the-penny” quotation accuracy.

The communication module may be further configured to transmit automated follow-up messages via at least one of email, SMS, or phone call. This ensures that users who abandon the process midway or need further encouragement receive timely reminders. These messages may include links to resume the quotation, limited-time discount offers, or scheduling links for virtual consultations. The system tracks open rates and user interactions to optimize communication strategies over time. This follow-up mechanism increases customer engagement and quote conversion.

The artificial intelligence engine may also be configured to provide material recommendations based on user preferences and regional availability. When a user specifies interest in premium shingles or green materials, the system may query supplier availability in the user's region and recommend matching SKUs. The AI may filter options by price, performance, or warranty term, depending on the user's expressed priorities. This makes material selection intuitive and reduces reliance on external research or sales intervention. Over time, machine learning can improve the relevance of these recommendations.

The display module may further be configured to generate a virtual representation of a roofing project including selectable options for roof type, material, and color. Each option dynamically updates the virtual visualization and quotation value, providing immediate visual and financial feedback. Users may experiment with different configurations, adjusting their selection based on appearance, cost, or functionality. The display module supports photorealistic rendering and comparative overlays. These interactive visuals foster decision confidence and reduce customer hesitancy.

The user computing device may comprise a mobile device, tablet, or desktop computer, and the platform is optimized for cross-platform compatibility. Users may access the system via a browser or dedicated mobile application. Responsive design ensures consistent functionality across screen sizes and device types. This supports homeowner engagement at any location or time. Device agnosticism is key to the system's wide usability.

The application server may be a cloud-hosted platform operable as software-as-a-service (SaaS). In this model, the system may be white-labeled or licensed to other roofing companies, enabling them to deploy the technology within their own customer ecosystems. The cloud configuration allows for centralized updates, real-time analytics, and secure access control. It also supports multiple simultaneous user sessions across different contractors. This model allows for horizontal scaling with minimal additional infrastructure.

The invention also encompasses a method for providing an artificial intelligence enabled virtual roofing quotation and visualization platform. The method includes receiving, at a user computing device, user input relating to a roofing project. Input may include address, preferred materials, scheduling preferences, or budget range. This data is transmitted to the application server for processing. The method may be initiated through a website, app, or embedded widget on a contractor's site.

The method further includes retrieving, via a data integration module, project data from one or more third-party databases. This step may involve APIs or secure file transfers from satellite imagery providers, regional price aggregators, or supplier inventories. Retrieved data is cross-referenced with user input for relevance and precision. Data preprocessing may include standardization, normalization, and filtering. The final structured data set is used in subsequent calculation steps.

The method includes automatically generating, using an estimation module, a plurality of line item estimates based on the user input and the project data. The line item estimates are calculated in real time, ensuring dynamic adaptability to changing inputs. The estimates form the foundational components of the roofing project quotation. Each estimate may be annotated with assumptions, source data, and variability ranges. This level of transparency enhances credibility with the user.

The method includes generating, via a quotation module, a roofing project quotation comprising the plurality of line item estimates. The quotation is formatted in both summary and detailed views. It may be downloadable or viewable within the platform interface. In some cases, the quotation may trigger document generation workflows for contracts and service terms. The quotation may also include links to initiate scheduling or payment.

The method includes adjusting, using an artificial intelligence engine, at least one of the plurality of line item estimates and the roofing project quotation based on updated user input. As the user interacts with the system, the AI engine reevaluates configuration preferences, real-time data, and past behavior. Adjustments are applied automatically and reflected on-screen with minimal latency. This ensures the quotation remains relevant and accurate. AI feedback loops enhance quote optimization over time.

The method includes transmitting, using a communication module, one or more communications related to the roofing project quotation to a homeowner. These communications may include quote confirmations, alerts for incomplete processes, promotional campaigns, or support outreach. Communication timing and frequency may be dynamically adjusted based on engagement analytics. The communication module ensures no opportunity is lost due to neglect or delays. Automated outreach enhances sales team efficiency.

The method includes displaying, via a display module, the roofing project quotation and a virtual representation of the roofing project on a user interface. The display enables interactive engagement with the project data and offers contextual visualization. This step ensures user comprehension and decision confidence. Embedded links or call-to-action buttons may facilitate immediate acceptance or further editing. The display also supports archiving and sharing functions.

In certain embodiments, a non-transitory computer-readable medium stores application instructions that, when executed by one or more processors, cause a computing system to perform operations including all steps of the aforementioned method. These instructions may be implemented in cloud infrastructure or embedded in local devices. They ensure continuity of service across distributed system architectures. Deployment may include failover, load balancing, and disaster recovery components. The software may also be secured using encryption and access control protocols.

The non-transitory computer-readable medium may further cause the system to generate a user profile including material preferences, location, and budget constraints; generate digital contract documents based on the finalized roofing project quotation; and process electronic payments via an integrated payment gateway upon acceptance. These features enable end-to-end automation of the roof-buying process. No external tools or manual steps are required. The system transforms a multi-day sales cycle into a seamless digital experience. This comprehensive workflow addresses long-standing inefficiencies in the home improvement industry.

In some embodiments, the application program may be configured to support home improvement projects beyond roofing, including but not limited to HVAC system upgrades, water heater installations, and ductwork repair. The communication module may deliver project-specific prompts to homeowners based on regional HVAC rebate programs, temperature trends, or seasonal maintenance cycles. The estimation module may retrieve pricing and labor rates for HVAC components from the third-party material database and contractor databases, enabling dynamic generation of a plurality of line item estimates for HVAC systems based on home size, unit capacity, and energy rating. The display module may generate 3D renderings of HVAC units installed within residential floorplans or exterior units positioned relative to the property's structure. The artificial intelligence engine may further analyze regional energy savings data to recommend efficiency-based upgrades or rebate-eligible equipment to the user.

The application program may also be used to facilitate solar panel design and quoting services. The user module may allow homeowners to input utility bills, select energy production goals, or indicate battery storage preferences. The data integration module may retrieve local solar irradiance data, slope and orientation details from the satellite imagery database, and equipment specifications from third-party material databases. The estimation module may then generate multiple system configurations with line item estimates for photovoltaic panels, inverters, mounts, batteries, installation labor, and permitting fees. The quotation module may compile these into selectable solar packages with energy output projections, return on investment metrics, and applicable incentives. The display module may render rooftop solar layouts, with toggles for production simulation and material selection.

For window or door replacement projects, the system may receive user input regarding window count, frame materials, energy ratings, and style preferences. The artificial intelligence engine may analyze historical weather patterns and local building codes to recommend suitable impact-resistant or insulated options. Third-party databases may provide dimensions, lead times, and bulk pricing for glass units and casings. The estimation module may calculate costs based on removal complexity, scaffold requirements, and sealing materials. The display module may present before-and-after views of installed windows with visual filters for tint, trim, and energy savings overlays. The communication module may trigger automated messages regarding scheduling, permit requirements, or contractor availability.

In another embodiment, the system may support landscaping and hardscaping projects such as patio installations, fencing, and exterior lighting. The user module may capture layout preferences, plant types, paving materials, and irrigation needs. The data integration module may query local zoning data, elevation models, and historical precipitation patterns. The estimation module may generate costs for grading, soil amendments, plantings, lighting fixtures, and labor. The artificial intelligence engine may optimize layout proposals based on sunlight exposure, slope, and user-provided priorities (e.g., privacy, sustainability). The display module may generate renderings showing yard transformations, material textures, and nighttime lighting effects, while the quotation module may present itemized bids with seasonal scheduling availability.

In some configurations, the platform may support garage conversions, ADU (accessory dwelling unit) planning, and interior remodeling. The user computing device may allow property owners to upload sketches, floor plans, or existing blueprints. The data integration module may pull local building codes, fire separation requirements, and utility capacity data. The estimation module may calculate costs for demolition, framing, plumbing, insulation, electrical work, and finishing materials. The artificial intelligence engine may suggest spatial optimizations or cost-effective design packages based on similar projects. The quotation module may include timelines, subcontractor phases, and permitting milestones, while the communication module may manage pre-construction coordination messages.

The system may also support whole-home energy audits and efficiency retrofits. Using historical weather database queries and real-time utility integrations, the AI engine may identify inefficiencies such as heat loss through attic spaces or outdated insulation. Users may be prompted to schedule blower door tests, duct sealing, or insulation upgrades. The estimation module may provide costs for each intervention, while the quotation module may offer bundled packages with rebate tracking. The display module may show thermal visualizations and expected energy savings, encouraging user engagement and approval. The communication module may push notifications about deadlines for rebate submission or optimal installation windows.

In still further embodiments, the platform may be used for home accessibility upgrades, including bathroom retrofits, ramp installations, stair lifts, and door widening. The user module may gather mobility needs, floor plan constraints, and equipment preferences. The data integration module may pull federal and state accessibility guidelines. The AI engine may suggest compliant configurations based on user mobility profiles and spatial limitations. The estimation module may provide costs for grab bars, lowered countertops, tile surfacing, waterproofing, and specialty fixtures. The display module may render room layouts with clearances, transfer zones, and equipment placement, while the quotation module tracks labor segments and compliance checklists.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a system architecture diagram of the network infrastructure, according to some embodiments;

FIG. 2 illustrates a block diagram of the computer system and application program, according to some embodiments;

FIG. 3 illustrates a flowchart of an example method for generating a virtual project quotation and visual representation, according to some embodiments;

FIG. 4 illustrates a workflow diagram showing the backend modular data processing of the application program, according to some embodiments; and

FIG. 5 illustrates a user flow diagram of interactions with the application program via a user computing device, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a system and method implemented as an artificial intelligence enabled system for a virtual roofing quotation and visualization platform. This system may allow homeowners to access a web-or app-based interface to initiate a roofing project quotation process, interact with real-time pricing models, and visualize proposed changes to their roof in a virtual environment. The system may include a combination of software modules deployed on an application server, as well as user interfaces delivered to a user computing device. The architecture may be modular, allowing each component to be updated or scaled independently. Communications between the user computing device and the application server may occur over a user network using secure protocols. Each component of the system may be designed to operate synchronously or asynchronously, depending on implementation requirements. Collectively, the components may allow end-to-end execution of the quotation workflow without requiring in-person site visits. The platform may streamline the roofing project lifecycle from planning through contract acceptance. All elements may interoperate using well-defined APIs or message queues to ensure reliable data exchange.

The user computing device may serve as the primary access point through which the user engages with the platform. The user computing device may include a mobile phone, tablet, laptop, or desktop computer and may run on any operating system capable of supporting modern web browsers or native applications. Through this device, a user may launch a user interface where they can input project-specific data, including their address, roof size or type, desired material specifications, and budget parameters. This information may be transmitted to the application server via the user network and processed by backend modules to generate initial quotations. The user computing device may also support the display of interactive visuals, 3D renderings, and real-time pricing changes based on user selections. Touch, voice, or keyboard inputs may be accepted, allowing flexible user interaction. Depending on implementation, the user computing device may store session data locally or request all content dynamically from the application server. The system may permit authentication via login credentials or guest access with optional profile creation.

The user network may include a wireless or wired Internet connection, mobile data network, or any communication infrastructure capable of supporting secure bidirectional data exchange. Data transmitted between the user computing device and the application server may be encrypted using SSL, TLS, or other secure transport protocols to ensure confidentiality and integrity. In some configurations, the network connection may be optimized using data compression or edge caching to reduce latency and enhance the user experience. The system may support network error handling routines to ensure data recovery and resumption of interrupted sessions. Bandwidth requirements may be minimal during initial data collection but may increase during high-resolution visual rendering or satellite data retrieval. The system may also be designed to operate under variable network conditions, including slow or intermittent connections.

An application server may operate as the central coordination point for the system. It may be responsible for routing user input to relevant modules, executing processing logic, and returning results to the user interface. The application server may include one or more processing nodes, load balancers, data stores, and container orchestration services. In a typical deployment, the server may run in a cloud environment using infrastructure-as-a-service (IaaS) or platform-as-a-service (PaaS) offerings. The application server may expose RESTful or GraphQL endpoints for client-server communication and may maintain session tokens for managing stateful interactions. Authentication and authorization may be handled through integrated identity providers or token-based access controls. The server may orchestrate tasks across subsystems such as estimation, visualization, and communication modules. Logging, monitoring, and alerting capabilities may also be present to enable system observability and maintenance.

A data integration module may be configured to receive project data from one or more third-party databases. These third-party databases may include satellite imagery providers, geographic information systems, weather forecasting services, roofing material distributors, contractor networks, and historic cost aggregators. Upon request, the data integration module may query one or more APIs using predefined schemas and credentials. The incoming data may then be normalized into a common format, validated for integrity, and cached for subsequent access. The module may handle retries, timeouts, and error codes gracefully to ensure continuity of service. For example, when a user inputs their home address, the data integration module may automatically query a satellite imagery service to retrieve roof dimensions and slope data. Similarly, it may call pricing APIs from distributors to retrieve current costs for materials such as shingles, underlayment, and fasteners. All data retrieved may be logged with timestamps and source metadata for traceability.

The data integration module may also support scheduled synchronization jobs to keep frequently accessed data up to date. This may include periodic refresh of price lists, supplier inventories, or regional labor rates. Data caching mechanisms such as Redis or Memcached may be employed to improve performance for common queries. If project data becomes stale or invalidated, the module may flag such instances and trigger a re-fetch or notify the user accordingly. The module may expose an internal API for other subsystems to retrieve enriched project data. Depending on the configuration, the module may also transform geospatial coordinates into roof plan diagrams usable by visualization tools.

An estimation module may be coupled to the data integration module and configured to automatically generate a plurality of line item estimates based on the project data. This module may include business logic engines, pricing calculators, and rules-based systems. For each roofing project, the estimation module may calculate line items including but not limited to base materials, accessories, labor, delivery, debris removal, and optional add-ons. It may apply region-specific multipliers, waste factors, and tax rules to derive accurate cost estimates. Unit costs may be sourced from third-party databases or internal pricing models defined by administrators. The output of the estimation module may be structured in a standardized format and include fields such as description, quantity, unit price, extended price, supplier ID, and SKU. The estimation module may permit real-time recalculation in response to user changes, such as altering the roof material or size.

The estimation module may also generate contingency line items for unexpected project conditions, such as steep slope surcharges or multi-layer tear-off requirements. Additional logic may permit bundling of line items into groups for better presentation. Historical project data may be leveraged by machine learning models embedded in the estimation module to recommend frequently bundled items. The module may also support audit trails to track the origin and justification of each cost component. Depending on configuration, line item rules may be defined through a domain-specific language or via a graphical rule editor accessible to administrators. The module may support versioning to reflect changes in pricing logic over time and allow rollbacks when necessary.

A quotation module may be configured to automatically generate a roofing project quotation comprising the plurality of line item estimates. This module may take structured output from the estimation module and arrange it into a format suitable for presentation and review. The roofing project quotation may be rendered in HTML for web viewing, in PDF for downloads, or as structured data for integration with CRMs. The quotation may include visual elements such as brand logos, headers, totals, breakdowns, and explanatory notes. Tax, shipping, and discounts may be applied as separate line items or folded into relevant categories. The quotation module may also generate summary sections showing subtotal, tax, and grand total, along with financing options if available. The module may support digital signature capture, approval tracking, and contract generation. An API may allow external systems to request or submit quotation data.

In some configurations, the quotation module may support multilingual templates and currency localization. Dynamic content rendering may allow real-time updates to reflect user inputs without requiring full page reloads. Approval workflows may be embedded within the module, allowing both the homeowner and contractor to negotiate, revise, and accept terms asynchronously. Quotes may be stored in a persistent database indexed by user ID, project address, and timestamp. Archived quotes may be reactivated or cloned for follow-on projects. The quotation module may also flag inconsistencies or missing inputs and prompt the user to correct them before submission.

A communication module may be configured to automatically transmit communications to a homeowner. These communications may be triggered by system events such as quotation creation, expiration, approval, or rejection. Message formats may include SMS, email, voice messages, or in-app push notifications. The module may include a templating engine that substitutes variables into predefined message formats using values such as username, quotation ID, or project cost. The communication module may also integrate with external marketing or CRM platforms via webhook or API. Logs of all messages sent may be maintained for compliance and analytics. Message delivery status, user responses, and opt-out preferences may be tracked using unique identifiers.

An artificial intelligence engine may be operatively connected to the estimation module and the quotation module and configured to dynamically adjust the plurality of line item estimates and the roofing project quotation based on user input. The artificial intelligence engine may analyze real-time user selections, regional data trends, historical quotation outcomes, and supplier availability to modify the estimates and recommendations displayed to the user. The AI engine may use supervised or unsupervised learning models, such as decision trees, neural networks, or clustering algorithms, to identify patterns and generate responsive adjustments. These adjustments may be reflected in updated totals, proposed bundles, or alternative product offerings that align with inferred user preferences or cost constraints. In one configuration, the engine may prioritize budget-friendly options when the user repeatedly declines high-cost suggestions. Conversely, premium options may be emphasized if the user selects high-end materials or extended warranties. The AI engine may continuously improve by retraining on anonymized user interaction logs.

The display module may be configured to generate a virtual display comprising the roofing project quotation and a virtual representation of a roofing project. The virtual representation may include annotated roof diagrams, rendered textures showing material samples, and configurable layers representing underlayment, shingles, flashing, and trim. The module may support user interaction through selection tools, sliders, or toggles that modify the appearance and configuration of the virtual roof. Each change may be reflected immediately in both the visualization and the roofing project quotation. Photorealistic rendering engines or lightweight 3D graphics libraries may be used to simulate natural lighting and angles. This visualization may increase user comprehension of scope and cost implications, particularly for non-technical users.

The system may also be embodied as a method for providing an artificial intelligence enabled virtual roofing quotation and visualization platform. The method may include receiving, at a user computing device, user input relating to a roofing project. The user input may be transmitted to an application server, where a data integration module retrieves relevant project data from third-party databases. An estimation module may then use this project data to generate a plurality of line item estimates. These estimates may be processed by a quotation module to generate a roofing project quotation, which may then be adjusted in real time by an artificial intelligence engine based on updated user input.

The method may include transmitting, using a communication module, one or more communications related to the roofing project quotation to a homeowner. These communications may alert the homeowner of quote readiness, revisions, approval deadlines, or scheduling availability. The method may further include displaying, using a display module, the roofing project quotation and a virtual representation of the roofing project on a user interface. The user interface may allow for real-time modification of materials, dimensions, or colors and reflect such changes immediately in cost projections and visualization output. In some embodiments, the method steps may be executed in a stateless or stateful session, depending on user authentication settings.

A non-transitory computer-readable medium may store application instructions that, when executed by one or more processors, cause the computing system to perform the operations described herein. These instructions may include initialization of the user interface, integration with satellite imagery services, retrieval of supplier pricing, application of pricing logic, user-specific configuration retrieval, and rendering of the quotation display. The computer-readable medium may further contain compiled machine learning models used by the artificial intelligence engine and interface templates used by the display module. Additional instructions may cause the system to generate a user profile based on project history, preferences, and geographic data. Upon acceptance of a roofing project quotation, the computing system may generate a contract document and initiate a payment flow using an integrated payment gateway.

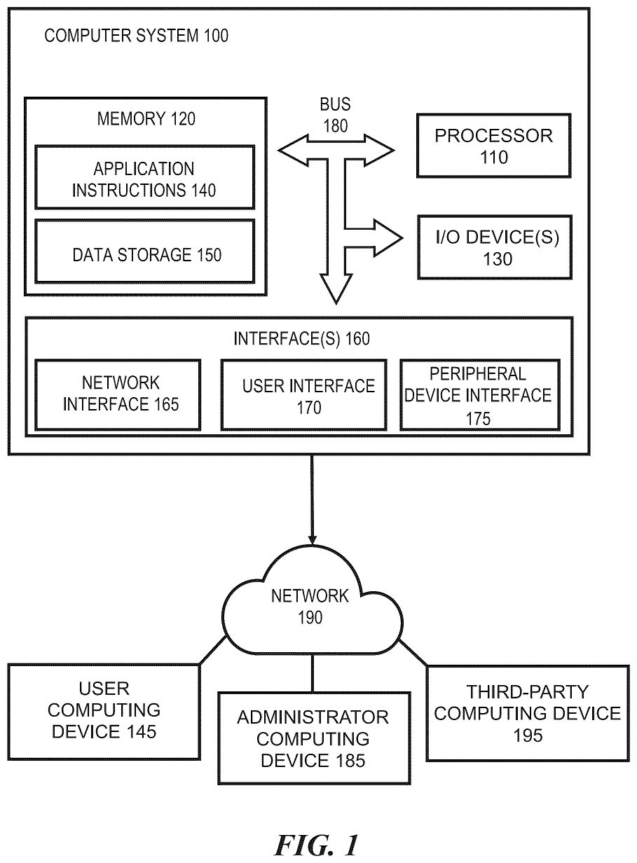

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

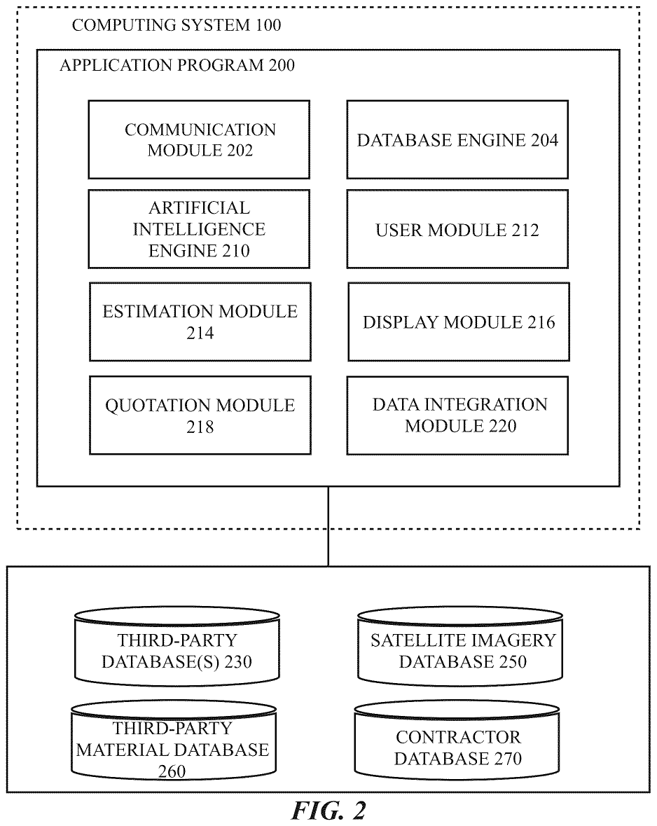

FIG. 2 illustrates an example computer architecture for the application program 200 operated via the computing system 100. The computing system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, an artificial intelligence engine 210, a user module 212, an estimation module 214, a display module 216, a quotation module 218, and a data integration module 220. The application program 200 is in communication with various third-party databases 230 such as a satellite imagery database 250, a third-party material database 260, contractor databases 270, a historical weather database 280, a quotation database 285, and a session/cache store 290.

The communication module 202 may be configured to transmit communications to users of the system including homeowners, contractors, or administrative personnel. These communications may be triggered by events such as quotation creation, expiration notices, updates to material pricing, or scheduling confirmations. The communication module 202 may support multiple channels including SMS, email, push notifications, and automated voice calls. The module may include a rule-based engine that defines conditions for message dispatch based on user actions or system events. Templates with placeholders may be dynamically populated with project-specific data such as quote ID, price totals, deadlines, or selected materials.

The communication module 202 may also include logic for managing user notification preferences, enabling each user to customize how and when they receive messages. Delivery confirmation mechanisms may verify successful receipt, and the module may log metadata such as delivery time, message ID, and response status. Integration with third-party communication APIs (e.g., Twilio, SendGrid) may allow the module to scale across high user volumes. Moreover, the module may also support bidirectional messaging, where user replies can be parsed for follow-up actions such as confirming approval or requesting assistance. These messages may be analyzed by the artificial intelligence engine 210 to infer sentiment or intent.

The database engine 204 may facilitate structured data operations across the computing system 100. It may be responsible for defining and enforcing data schemas for all entities stored in one or more underlying databases, including users, quotations, material catalogs, contractor profiles, and visual asset metadata. The engine may provide both synchronous and asynchronous query processing depending on performance requirements. It may support transactional consistency for multi-step workflows such as generating and approving a quotation.

In some implementations, the database engine 204 may use a combination of relational databases (e.g., PostgreSQL) and document-based stores (e.g., MongoDB) to accommodate structured and semi-structured data. Data models may be versioned to allow backward compatibility as the platform evolves. Advanced features such as full-text search, indexing, foreign key constraints, and caching may be employed to optimize performance. In support of auditing and analytics, the database engine 204 may expose logging interfaces that stream data access patterns and modification events to centralized monitoring tools. Scheduled backups, encryption-at-rest, and failover replication may also be implemented for reliability.

The artificial intelligence engine 210 may provide learning-based insights and dynamic adaptations throughout the quotation generation and visualization workflow. It may be operably connected to multiple other modules and engines, ingesting input data such as user selections, regional pricing trends, project metadata, and historical acceptance rates. It may execute predictive models trained on labeled datasets to recommend cost-saving material combinations, detect likely rejection points in a quotation, or optimize layout for roofing components.

In one configuration, the artificial intelligence engine 210 may include a real-time inference subsystem and an offline model training subsystem. The real-time subsystem may respond to user inputs by immediately updating line item pricing, swapping suppliers, or suggesting alternate materials. The training subsystem may run batch processes using feedback data (e.g., accepted vs. rejected quotations) to improve the accuracy and personalization of recommendations. The AI engine 210 may also flag anomalous pricing based on deviations from regional averages or generate insights such as “Users in your area commonly choose X material for similar roofs.”

Additionally, the engine may provide explanations alongside its recommendations, increasing user trust. For example, when suggesting a higher-cost underlayment, the system may cite its extended warranty in regions with heavy rainfall as justification. The artificial intelligence engine 210 may also work in concert with the display module 216 to personalize the visualization and highlight upgrades likely to increase property value or energy efficiency.

The user module 212 may serve as the central point of interaction between users and the system. It may host front-end interfaces rendered in web browsers or mobile applications and may manage session state, input validation, and authentication. The module may allow users to input project details including address, desired roofing materials, preferences for financing, and optional upgrades. In some embodiments, the module may support authentication via third-party identity providers (e.g., Google, Apple) or offer guest access modes for quote previews.

Interactive UI components supported by the user module 212 may include dropdown selectors for roofing types, sliders for budget constraints, checkboxes for optional add-ons, and maps for property boundary confirmation. Data entered by the user may be immediately validated and sent to the application server or cached locally. The user module 212 may communicate with the AI engine 210 to adapt the layout or recommend options based on inferred user profiles. The module may also support file uploads (e.g., prior roof photos or insurance documents) and may expose a dashboard summarizing quote history, approvals, and messages.

The estimation module 214 may be configured to automatically generate a plurality of line item estimates based on project data. It may retrieve normalized data from the data integration module 220 and apply pricing logic to produce per-item costs for labor, materials, disposal, and installation complexity. The module may include configuration rules based on roof geometry, size, slope, and access limitations. Each line item may include fields for part numbers, quantity, unit cost, markup, and subtotal.

The module may also compute environmental modifiers such as hot weather installation surcharges or hurricane-rated component requirements. It may run Monte Carlo simulations or sensitivity analyses to evaluate pricing tolerance bands and generate alternate estimate scenarios. For enterprise users, the estimation module 214 may support integration with ERP systems or export of quote line items in CSV or JSON formats. Each estimate may be timestamped, version-controlled, and stored within the quotation database 285.

The display module 216 may generate the virtual representation of the roof and visually present the quotation. It may be implemented using WebGL, Three.js, or other real-time rendering frameworks and may render photorealistic or schematic views of the roof structure. The user may toggle between material options and observe immediate changes in both appearance and cost. The display module 216 may include interactive elements for zooming, rotating, and clicking on roof sections to explore sub-component pricing.

The display module 216 may also support AR overlays or side-by-side comparisons of existing and proposed roof states. Integration with the satellite imagery database 250 may allow automatic outline tracing and texturing based on current aerial images. Users may select visualization presets such as “Energy Efficiency” or “Curb Appeal” that apply theme-specific highlighting and annotations. Visualizations may be exported in image or video formats for client presentations or insurer submissions.

The quotation module 218 may receive the line item estimates and generate a formal quotation, combining line items into categories and appending metadata such as validity period, supplier details, and license numbers. The module may generate downloadable documents (PDF, DOCX), enable e-signature integrations, and allow users to accept or revise quotations. It may also compute total project cost, include financing options, and present discount tiers.

In some configurations, the module may allow for dual-pane quote comparisons or toggling between “base” and “premium” configurations. Users may request revisions via the interface, and all modifications may be logged and versioned. Once accepted, the quotation module 218 may trigger job scheduling or contract generation workflows in integrated systems. Historical quote data may be used by the AI engine 210 for predictive modeling.

The data integration module 220 may orchestrate retrieval and formatting of third-party data. It may interact with REST APIs, FTP endpoints, or webhook push feeds to ingest data including material costs, contractor schedules, and climate zones. Normalization routines may standardize units, convert currencies, and apply data-quality rules.

This module may also handle token refreshes, schema changes, and retry logic for failed requests. Cached responses may be stored for defined intervals to reduce API call volumes. Metadata tags may be appended to indicate source, timestamp, and trust level. The module may provide a service layer for other engines to query real-time or historical external data.

Third-party databases 230 may include external systems that provide project-relevant data to the platform. These may include the satellite imagery database 250, which offers roof shape, slope, and size measurements extracted from high-resolution imagery. The third-party material database 260 may store up-to-date product SKUs, lead times, bulk discounts, and material certifications. Contractor databases 270 may store contact information, license status, project history, and availability schedules for labor partners.

The historical weather database 280 may provide temperature, precipitation, and wind exposure history for project addresses, which may influence warranty selection or installation timing. Quotation database 285 may store finalized and in-progress quotes indexed by project ID and user. The session/cache store 290 may store temporary session state, interface context, visualization snapshots, or in-progress configuration states to allow seamless continuation across page loads or devices.

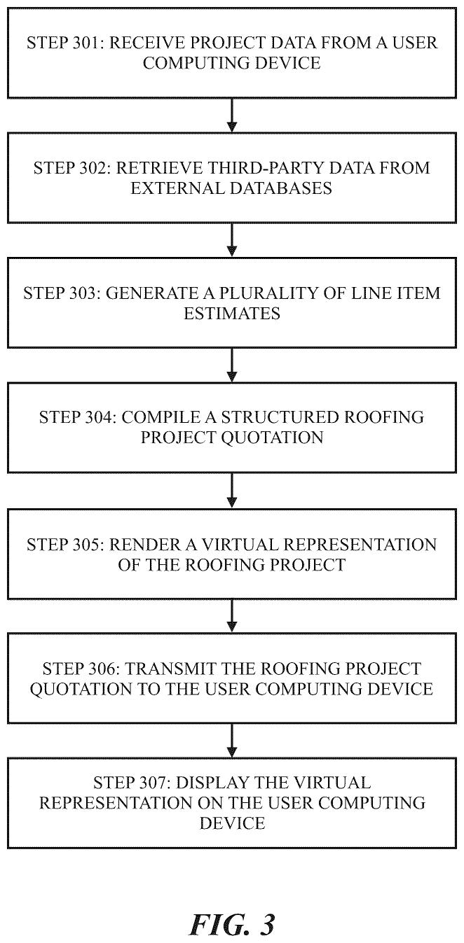

FIG. 3 illustrates a flowchart representing an example method for generating a virtual roofing project quotation and visual representation, as performed by the application program 200 operating on the computing system 100. The method comprises a series of sequential steps, for enabling a user to receive an interactive and dynamically generated quotation accompanied by a visual representation of the project. Each step may be executed by one or more modules or engines discussed above in relation to FIG. 2. Although the method is illustrated as a linear sequence, alternative implementations may involve asynchronous processing, caching, or step combinations depending on system configuration.

At step 301, the method may include receiving from a user computing device over a user network, project data associated with a roofing project. This data may include the property address, user-selected roofing material preferences, budget constraints, and optional features such as solar panels or upgraded underlayment. The user computing device may transmit this data through an interface rendered by the user module 212. The data may be validated locally on the device or server-side, then forwarded to the application server for processing. In some embodiments, GPS location data may be captured to further refine project context.

In some configurations, the user module 212 may offer autocomplete and address normalization based on geolocation services, reducing manual data entry errors. Project data may be formatted into structured objects and tagged with session identifiers for tracking within the system. Once received, the project data may be queued for further enrichment by downstream modules.

At step 302, the method may include retrieving, via a data integration module, supplemental project data from one or more third-party databases. The data integration module 220 may issue real-time API calls or access pre-fetched datasets from satellite imagery database 250, third-party material database 260, contractor databases 270, and historical weather database 280. Supplemental data may include roof pitch and dimensions, regional material costs, contractor availability, and local weather risk factors such as wind speed or precipitation levels. Each data source may be queried using identifiers derived from the user's property address or location metadata.

To enhance reliability, the data integration module 220 may include fault-tolerant logic and may employ data versioning or timestamp filters to ensure freshness. Retrieved data may be normalized into platform-specific formats and merged with user-provided data to form a comprehensive project profile. This enriched data set may then be passed to the estimation module for further processing.

At step 303, the method may include generating, by an estimation module, a plurality of line item estimates associated with the roofing project. The estimation module 214 may calculate costs for shingles, labor, flashing, debris removal, and optional enhancements such as insulation or extended warranties. The estimation module may apply pricing formulas that consider regional labor rates, material availability, roof complexity, and waste margins. Each line item may include a detailed breakdown including quantity, unit cost, markup percentage, and subtotal.

The estimation module 214 may also implement dynamic pricing adjustments based on demand fluctuations, historical price trends, or promotional discounts. Rules-based logic may handle special conditions such as steep roof slopes, multiple-layer tear-offs, or code compliance requirements. The resulting set of line item estimates may be stored temporarily or persistently in the quotation database 285.

At step 304, the method may include compiling, by a quotation module, the plurality of line item estimates into a roofing project quotation. The quotation module 218 may categorize line items into logical sections such as Materials, Labor, Equipment, and Services, then compute total costs, taxes, discounts, and final price. The quotation may include metadata such as expiration date, creation timestamp, reference ID, and contractor license number. A formatted version of the quotation may be prepared for display and optional download by the user.

In some embodiments, the quotation module 218 may apply business logic such as price rounding, bundle suggestions, or tiered pricing for multi-property clients. A digital signature component may be enabled to facilitate user approvals and execution of service agreements. Quotations may also be version-controlled, allowing users to revisit prior configurations and compare alternatives.

At step 305, the method may include dynamically adjusting, by an artificial intelligence engine, at least one of the plurality of line item estimates and the roofing project quotation based on user input. The artificial intelligence engine 210 may monitor user interactions with the interface to detect patterns such as repeated material changes, scrolling behavior, or toggling of optional features. Based on this data, the engine may modify unit costs, propose discounts, or suggest material alternatives more likely to be accepted.

The engine may also adjust pricing or configurations based on user profile data, regional trends, or acceptance probabilities derived from similar past projects. These adjustments may be reflected in real-time in the quotation display and may include explanations such as “This material has a faster install time with equivalent durability.” AI-driven adjustments may improve engagement and conversion rates by reducing manual trial-and-error from the user.

At step 306, the method may include transmitting, via a communication module, a message associated with the roofing project quotation to the user computing device. The communication module 202 may package the message using a pre-configured template that incorporates project name, total cost, deadline for acceptance, and a call-to-action. Delivery may occur over email, SMS, in-app notification, or push alert depending on user preferences and device type. A tracking ID may be assigned to each message instance for delivery status monitoring.

Additional metadata such as delivery timestamp, user open/read status, and follow-up scheduling may be logged in the communication log. The communication module 202 may also receive replies or clicks from users and route those to the application server for further processing. These interactions may be used to trigger subsequent workflow steps such as scheduling or configuration locking.

At step 307, the method may include displaying, via a display module, a virtual representation of the roofing project quotation. The display module 216 may render a 3D or 2D image of the roof using aerial imagery data and project configuration inputs. Visual overlays may show selected materials, components, and work zones. Interactive controls may allow users to zoom, pan, rotate, or toggle between “before” and “after” visualizations.

The display module 216 may synchronize with the quotation module 218 so that visual changes update pricing in real-time. Tooltips or labels may appear when users hover over parts of the roof, displaying material names, quantities, and associated line item costs. This visual context may improve comprehension and confidence in the quotation, supporting user decision-making and approval.

In alternative embodiments, the application program 200 may be used to generate interactive quotations and virtual visualizations for a variety of home improvement projects that are unrelated to roofing. For example, the system may be employed in the planning and procurement of HVAC installations. The user module 212 may allow users to enter home size, layout constraints, and preferences such as energy efficiency or noise level. The data integration module 220 may retrieve relevant supplemental project data including historical weather patterns, local rebate availability, and manufacturer specifications from third-party material databases. The estimation module 214 may then generate a plurality of line item estimates for HVAC units, ductwork, thermostats, installation labor, and electrical modifications. The quotation module 218 may compile the data into a structured proposal, while the display module 216 may render diagrams of system placement and airflow coverage. The artificial intelligence engine 210 may dynamically adjust component selection based on utility cost forecasts and historical acceptance data, and the communication module 202 may deliver updates and approvals across multiple devices.

The same architecture may be adapted for use in planning solar energy installations. A user may initiate a solar project through the user module 212 by entering utility consumption, desired offset percentages, and optional battery preferences. The data integration module 220 may retrieve sun exposure data, slope orientation, shading patterns from satellite imagery database 250, and applicable rebates or net metering rules. The estimation module 214 may compute line item estimates for panels, racking, inverters, batteries, and permitting. The artificial intelligence engine 210 may predict energy yield and suggest optimal configurations based on property orientation and historical installation data. The quotation module 218 may produce a comparison of basic and premium systems, while the display module 216 may render a virtual overlay of the proposed solar array on the property.

For window and door replacement projects, the application program 200 may be employed to collect user selections through the user module 212 regarding window count, style, frame material, and energy rating. The data integration module 220 may query regional energy codes, glass performance ratings, and local supplier availability. The estimation module 214 may generate cost breakdowns for removal, disposal, trim work, and glass options. The artificial intelligence engine 210 may recommend upgrades such as impact-resistant windows in storm-prone regions or UV filtering coatings based on regional sun exposure data. The quotation module 218 may organize pricing by room or window group, and the display module 216 may illustrate installed views or cross-sectional diagrams showing thermal insulation properties.

In some embodiments, the system may support interior remodeling projects such as bathroom or kitchen renovations. The user module 212 may guide the user through configuration options like cabinet styles, plumbing fixture finishes, and appliance selections. The data integration module 220 may retrieve plumbing code requirements, water pressure data, and availability of subcontractors. The estimation module 214 may generate cost estimates for demolition, framing, electrical and plumbing labor, tiling, and finishing. The artificial intelligence engine 210 may recommend layout optimizations or bundled material selections based on trends and spatial analysis. The display module 216 may render 3D or augmented reality representations of the remodeled interior, and the communication module 202 may coordinate scheduling and approval messaging.

The application program 200 may also be applied to landscape architecture and exterior hardscape projects. Through the user module 212, users may enter preferences such as desired plant species, irrigation systems, or patio materials. The data integration module 220 may access regional soil data, sunlight availability, and drought resistance scores for vegetation. The estimation module 214 may calculate costs for excavation, planting, paving, irrigation installation, and lighting. The artificial intelligence engine 210 may recommend configurations optimized for sustainability or low maintenance. The display module 216 may provide top-down views and elevation illustrations of the proposed design.

In another embodiment, the system may be used to generate quotations and virtual visualizations for fencing and privacy barrier installations. The user module 212 may collect inputs such as desired material (e.g., wood, vinyl, metal), height, linear footage, and gate placement. The data integration module 220 may retrieve setback restrictions, local wind load requirements, and availability of materials from third-party sources. The estimation module 214 may generate costs for posts, fasteners, gates, labor, and surface treatment. The artificial intelligence engine 210 may offer layout suggestions to minimize cuts or waste. The display module 216 may show side profiles, panel groupings, and cross-sectional hardware layouts.

The application program 200 may also support insulation upgrades. Users may enter the age of the structure, attic configuration, and existing insulation type through the user module 212. The data integration module 220 may access regional heating and cooling demand data, building code requirements, and insulation R-values. The estimation module 214 may generate quotes for blown-in, spray foam, or batt insulation types, including labor and equipment rentals. The artificial intelligence engine 210 may recommend the most cost-effective or energy-efficient solutions based on seasonal temperature patterns and rebate programs. The display module 216 may visualize areas of the home receiving upgrades and anticipated thermal efficiency improvements.

Home accessibility improvements may also be facilitated using the same system architecture. The user module 212 may collect accessibility needs related to mobility, vision, or aging in place. The data integration module 220 may pull guidelines from the ADA or local equivalents, as well as product catalogs for ramps, stair lifts, and modified fixtures. The estimation module 214 may calculate installation costs for grab bars, widened doorways, zero-threshold showers, and handrails. The artificial intelligence engine 210 may recommend safety enhancements or bundled upgrades based on household occupancy and mobility constraints. The display module 216 may produce annotated diagrams of proposed installations, and the quotation module 218 may provide documentation for insurance or reimbursement claims.

The application program 200 may further be used to support whole-home energy audits and retrofitting initiatives. The user module 212 may guide property owners through inputting utility usage and suspected areas of inefficiency. The data integration module 220 may query smart meter data, weather history, and insulation records. The estimation module 214 may generate costs for sealing, weather stripping, replacing HVAC systems, or upgrading windows. The AI engine 210 may prioritize retrofit recommendations based on return on investment, emission reductions, or rebate eligibility. The display module 216 may visualize energy loss areas and estimated efficiency gains post-retrofit.

In some configurations, the system may facilitate home security upgrades, including doorbell cameras, smart locks, and motion-activated lighting. The user module 212 may allow the homeowner to specify existing infrastructure and desired features. The data integration module 220 may fetch product specs, compatibility guidelines, and cloud service costs. The estimation module 214 may generate proposals for bundled device installation, and the AI engine 210 may recommend packages based on crime data or user priorities. The display module 216 may render device placements on the home exterior.

Additionally, the application program 200 may be extended to manage smart home automation systems. The user module 212 may assist users in selecting devices such as thermostats, lighting systems, voice assistants, or window shades. The data integration module 220 may retrieve compatibility matrices, firmware updates, and network topology recommendations. The estimation module 214 may calculate installation time and costs for integrating disparate systems. The AI engine 210 may suggest automation sequences, energy saving schedules, or device groupings. The display module 216 may render network diagrams and user interface mockups.

In all these alternative embodiments, the underlying platform architecture remains consistent with the system and methods described throughout this application. Each module and engine, user module 212, data integration module 220, estimation module 214, artificial intelligence engine 210, quotation module 218, display module 216, and communication module 202, may operate independently or in coordination to enable a comprehensive, data-driven, and user-centric experience for planning and executing a wide array of home improvement projects.

These examples illustrate that the scope of the disclosed system is not limited to roofing projects but may be adapted for use across the broader residential improvement ecosystem. The modular nature of the architecture allows for high scalability, project type flexibility, and enhanced personalization through artificial intelligence integration. By maintaining consistent data ingestion and visualization pipelines, the application program 200 may be readily configured to support current and future homeowner needs in both interior and exterior renovation domains.

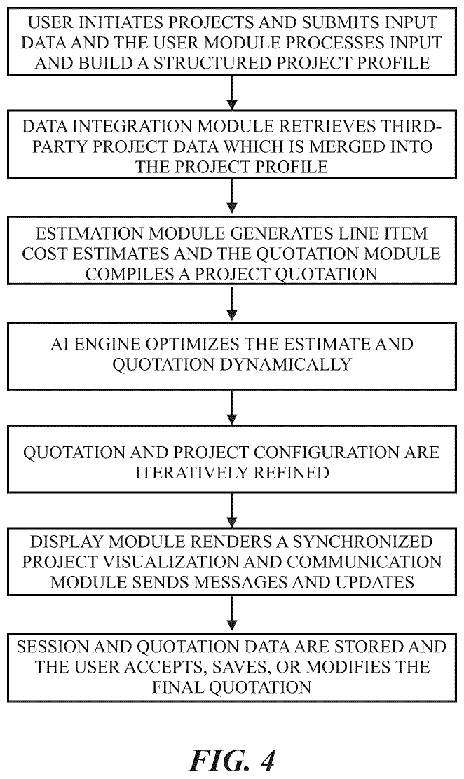

FIG. 4 illustrates a workflow diagram for the AI-enabled interactive quotation and virtual home improvement product and service buying system. The workflow demonstrates how the computing system 100, operating the application program 200, executes a sequence of operations across multiple modules and engines to dynamically generate quotations and render virtual representations of home improvement projects. The process begins with a user initiating a project via the user computing device, which transmits project initiation data through the user network to the application server. The user module 212 receives and processes user inputs, including address, preferences, budgetary constraints, and selected service category (e.g., roofing, HVAC, solar). These inputs are converted into a structured project profile that can be passed through the application workflow.

Once project data is received, the data integration module 220 retrieves supplemental project data from various external sources. These may include satellite imagery from satellite imagery database 250, current material costs from third-party material database 260, labor availability from contractor databases 270, and historical weather trends from historical weather database 280. The data integration module 220 normalizes and merges this data into the project profile, enriching the context for accurate estimation. The enriched data is then transmitted to the estimation module 214, which generates a plurality of line item estimates corresponding to the identified scope of work. Each line item may include cost components, quantities, markup values, and projected timelines.

Following this, the quotation module 218 compiles the individual line item estimates into a cohesive roofing project quotation or non-roofing project quotation, depending on the selected service. The quotation module 218 may incorporate tax calculations, discounts, project metadata (e.g., expiration date, quote ID), and legal disclosures. The artificial intelligence engine 210 concurrently monitors user interactions, project complexity, and previous quote outcomes to refine the estimate or propose alternative configurations. Based on learned preferences, system heuristics, and contextual variables, the AI engine 210 may suggest substitutions, optimize cost-to-value ratios, or reconfigure sequences. Adjustments may be fed back into the estimation module 214 and quotation module 218 iteratively until a satisfactory configuration is reached.

The display module 216 renders a visual representation of the project, synchronized with the current quotation. For roofing or exterior work, the display may include 3D top-down views with applied materials and annotations. For interior work, renderings may include floorplans, elevation views, or virtual room mockups. Simultaneously, the communication module 202 initiates outbound messaging to the user computing device, which may include project updates, approval requests, or quote summaries. Persistent and intermediate data are stored within the quotation database 285 and session/cache store 290, enabling continuity across multiple user sessions and configuration versions. The workflow concludes when the user either accepts the quotation, saves it for future consideration, or requests modifications.

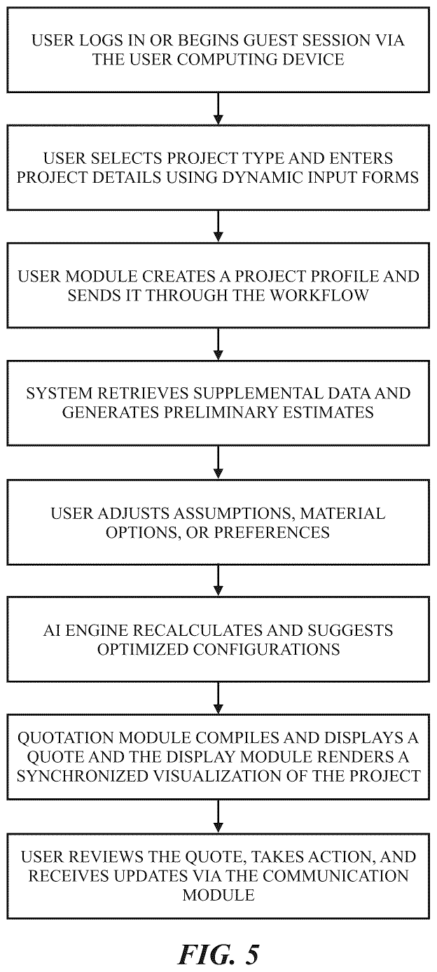

FIG. 5 illustrates a user flow diagram demonstrating the sequence of interactions between a user and the AI-enabled interactive quotation and visualization platform, as facilitated by the application program 200. The process begins with user authentication or guest session initialization on a user computing device. Through the user module 212, the user selects a project type (e.g., roofing, HVAC, solar, insulation) from a provided interface. Based on the project type, the system customizes the subsequent forms or input interfaces to collect relevant data such as service location, material preferences, size, or scope of work.

Once initial project data is entered, the user is presented with a summary of project assumptions and preliminary estimates derived from third-party databases queried via the data integration module 220. The user may interact with these assumptions, making adjustments to material types, quantities, or optional add-ons. Each user interaction may trigger the artificial intelligence engine 210 to recalculate or recommend more optimal configurations. The revised estimates are then presented to the user in a structured quotation, compiled by the quotation module 218. Interactive features on the interface allow the user to toggle between quote versions, select upgrade paths, or view per-line cost details.

Simultaneously, the display module 216 provides an interactive visualization of the project scope. For roofing or solar, this may include layered renderings of the rooftop. For HVAC or interior remodels, the display may feature floorplan visualizations, airflow diagrams, or renderings of remodeled spaces. The user may rotate, zoom, or toggle between design options to better understand the quoted proposal. Annotations may be shown on hover or tap, linking display elements to corresponding quotation line items. The visualization updates dynamically with each material or configuration change.

After reviewing both the quotation and visualization, the user may proceed to take action. Available options may include accepting the quotation, saving it for comparison, or requesting a revision. Upon acceptance, the user may be guided through a contract execution flow, scheduling preferences, or payment processing. The communication module 202 may deliver status updates and appointment confirmations via SMS, email, or in-app messaging. If the quote is saved, the session/cache store 290 ensures that the user's progress is preserved and can be reloaded upon return.

Throughout the entire flow, the user remains in continuous interaction with a responsive and adaptive interface that reflects backend recalculations and visual adjustments in near real-time. This user-centric approach, supported by backend module orchestration, provides an end-to-end digital experience for planning, quoting, and visualizing home improvement projects. While the flow illustrated in FIG. 5 represents a general structure, it may be customized further based on project type, geographic location, or user preferences.

Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. An artificial intelligence enabled system for a virtual roofing quotation and visualization
platform, the system comprising:
at least one user computing device in operable connection with a user network;
an application server in operable communication with the user network, the application server configured to enable the visualization, generation, and interaction with a roofing project quotation;
a data integration module to receive a plurality of data from one or more third-party databases and to distribute data to:
an estimation module to automatically generate a plurality of line item estimates;
a quotation module to automatically generate a quotation comprising the plurality of line item estimates;
a communication module to enable the automated transmission of communications to a homeowner;
an artificial intelligence engine to dynamically adjust the plurality of line item estimates and the quotation based on a plurality of user inputs; and
a display module to provide a virtual display on an application program, the virtual display comprising a virtual quote and a virtual representation of a roofing project.

2. The system of claim 1, wherein the data integration module is configured to retrieve project data from satellite geospatial databases.

3. The system of claim 1, wherein the estimation module is configured to generate the plurality of line item estimates using proprietary pricing algorithms based on the project data.

4. The system of claim 1, wherein the communication module is configured to transmit automated follow-up messages via at least one of email, SMS, or phone call.

5. The system of claim 1, wherein the artificial intelligence engine is further configured to provide material recommendations based on user preferences and regional availability.

6. The system of claim 1, wherein the display module is configured to generate a virtual representation of a roofing project including selectable options for roof type, material, and color.

7. The system of claim 1, wherein the user computing device comprises a mobile device, tablet, or desktop computer.

8. The system of claim 1, wherein the application server is a cloud-hosted platform operable as software-as-a-service (SaaS).

9. The system of claim 1, wherein the artificial intelligence engine is further configured to adapt the roofing project quotation based on regional pricing trends and seasonal availability data retrieved from the one or more third-party databases.

10. The system of claim 1, wherein the display module is further configured to render a side-by-side comparison of multiple roofing project quotations based on variations in the plurality of line item estimates.

11. The system of claim 1, wherein the user computing device is further configured to digitally execute a contract corresponding to the roofing project quotation using an integrated digital signature module.

12. A method for providing an artificial intelligence enabled virtual roofing quotation and visualization platform, the method comprising the steps of:
receiving, at a user computing device, user input relating to a roofing project;

13. The method of claim 12, further comprising the step of verifying the geographic location of the roofing project based on satellite image data.

14. The method of claim 12, further comprising the step of presenting the user with an interactive guide through each step of the roofing project quotation process.

15. The method of claim 12, wherein the step of generating the plurality of line item estimates comprises calculating quantities of roofing materials based on satellite-derived roof measurements.

16. The method of claim 12, wherein the step of transmitting communications includes sending reminders to the homeowner to complete or approve the roofing project quotation.

17. A non-transitory computer-readable medium storing application instructions that, when executed by one or more processors, cause a computing system to perform operations comprising:
receiving user input relating to a roofing project via a user interface;

18. The non-transitory computer-readable medium of claim 17, wherein the operations further comprise generating a user profile including material preferences, location, and budget constraints.

19. The non-transitory computer-readable medium of claim 17, wherein the operations further comprise generating digital contract documents based on the finalized roofing project quotation.

20. The non-transitory computer-readable medium of claim 17, wherein the operations further comprise processing electronic payments via an integrated payment gateway upon acceptance of the roofing project quotation.
